(19) United States
(12) Patent Application Publication
(10) Pub. No.: US 2007/0237566 A1
(43) Pub. Date: Oct. 11, 2007

(54) Tethered stationery products

(76) Inventors: Jason S. Silverstein, Chicago, IL (US); Howard L. Danzyger, South Elgin, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/401,576

(22) Filed: Apr. 11, 2006

(51) Int. Cl. B43K 23/02

(52) U.S. Cl. 401/131; 401/195

(57) ABSTRACT

The disclosure is generally directed to a tethered writing instrument that includes a tether and an opening. The tether terminates in slightly expanded mating portion that is adapted to be releasably secured in an opening, thereby forming a closed loop. The writing instrument is securable to an object to prevent loss of the writing instrument.

### BACKGROUND OF THE DISCLOSURE

1. Field of the Disclosure

The disclosure is generally directed to securable stationery products and, more particularly, to stationery products having a tether.

2. Brief Description of Related Technology

Consumers, especially children, frequently lose writing instruments. Similarly, consumers often misplace writing instrument caps, but not the writing instruments themselves. Accordingly, it is desirable to secure writing instruments so that they remain in a desired location such that they are not lost or misplaced. Conventional methods of securing writing instruments include attaching a flexible cord or chain to one end of the writing instrument and securing the other end of the flexible cord to a base which can be mounted on a stationary object, such as, for example, a desk or counter. Such writing instruments may be found in many locations, for example, supermarkets, banks and other financial institutions.

However, such writing instrument are generally difficult to remove once attached to the base. For example, many attachable writing instruments use a ball-type chain and a socket-type receiver to anchor the chain to the base. This type of writing instrument is only securable to particular locations having the required base.

One product that allows consumers to choose a particular location to attach the writing instrument is the STAY PUT PEN® available from Eldon Office Products (Oakbrook, Ill.). This product includes a writing instrument attached to a base via a cord. The base includes an adhesive on one side which is used to attach the base to an object. Thus, the user may choose a particular location for locating the base. Once attached, however, the base is relatively fixed and not movable. Thus, this type of writing instrument can only be used in the vicinity of the object to which the base is attached.

Other methods of securing writing instruments include using lanyards attached to the writing instrument. These lanyards enable the writing instrument to hang on a post, or around one's neck, for example, thereby allowing the writing instrument to be (removably) placed in a certain desired location. However, because the lanyard is simply placed over the object, the writing instrument is not secured to the object. Additionally, a lanyard can only be placed around an object having a projection of some sort because the lanyard does not have any free ends.

### BRIEF DESCRIPTION OF THE DRAWINGS

Exemplary aspects and features of a tethered writing instrument in accordance with the disclosure are described and explained in greater detail below with the aid of the drawing figures in which:

FIG. 1 is a perspective view of an exemplary tethered writing instrument according to the disclosure;

FIG. 2 is a partially exploded view of the tethered writing instrument of FIG. 1;

FIG. 3 is a perspective view of the cap of the tethered writing instrument of FIG. 1 showing a securing operation;

FIG. 4 is a perspective view of the cap of the tethered writing instrument of FIG. 1 showing the writing instrument in a secured configuration;

FIG. 5 is a perspective view of a second embodiment of a tethered writing instrument according to the disclosure; and

FIG. 6 is a perspective view of the tethered writing instrument of FIG. 1 secured to an object.

### DETAILED DESCRIPTION

The disclosure provides tethered stationery products including but not limited to tethered writing instruments (for example, ball point pens, fountain pens, permanent markers, dry erase markers, and highlighting markers, pencils), tethered erasers, tethered rulers, and tethered pencil sharpeners.

The tethered writing instrument described herein generally includes a writing portion and a cap, but the writing instrument may also be a retractable writing instrument (which generally does not include a cap). In one embodiment, the cap further includes a flexible tether attached to one end thereof and an opening on an extension of the cap. In another embodiment, the tether and opening may be disposed on the writing portion itself, for example, of a retractable writing instrument. Attaching the tether to the cap rather than to the writing instrument itself provides the advantage of allowing the user to access the writing instrument without removing the tether from its secured position.

The flexible tether is preferably made of rubber or flexible plastic. The tether may be secured to a fin extending from a distal end of the cap. The tether may terminate in a slightly expanded mating portion which is capable of being inserted into the opening. Once inserted into the opening, the tether forms a closed flexible loop adapted to secure the tethered writing instrument to virtually any object that the tether can fit around.

In yet another embodiment, two tethers could be attached to the cap or writing portion. In this embodiment, the first tether terminates in a slightly expanded mating portion and the other tether has an opening at its distal end.

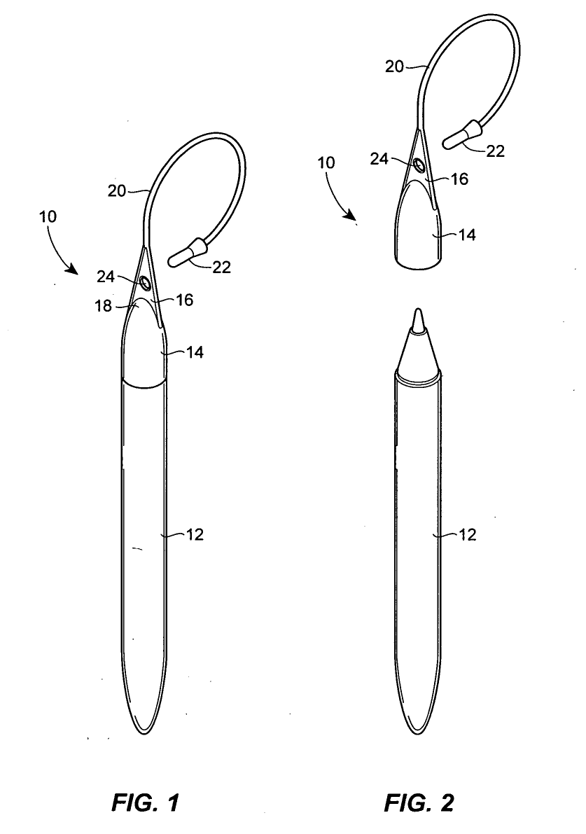

FIG. 1 shows a first embodiment of a tethered writing instrument 10 constructed in accordance with the teachings of the disclosure. The tethered writing instrument 10 includes a writing portion 12 and a cap portion 14. In the illustrated embodiment shown, the cap portion 14 has a fin 16 extending from a closed cap end 18, and a flexible tether 20 is attached to the fin 16 distal to the cap. A free end of the tether 20 terminates in a mating portion 22. As shown in the illustrated embodiment, the fin 16 also includes an opening 24, but the opening 24 may alternatively be disposed in the cap portion 14 or in the writing portion 12.

FIG. 2 shows the tethered writing instrument 10 in an exploded view. In this view, it is apparent that the writing portion 12 can be accessed regardless of the configuration of the tether 20 (i.e., whether the tether is in a secured configuration or in an open configuration). The tether 20 allows the writing instrument 10 to be secured to an object to prevent it from becoming lost, for example during an outdoor activity. However, the writing portion 12 can be accessed and used by simply removing the writing portion 12 from the cap 14 should the consumer need for the writing portion 12, for example, to record a score or a time. Thus, the writing portion 12 remains usable even when the tethered writing instrument 10 is secured.

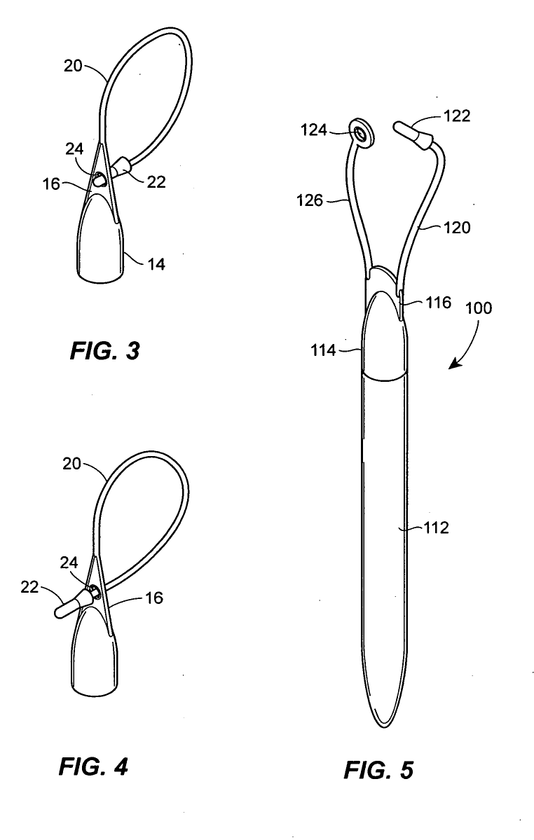

FIG. 3 shows a securing operation wherein the mating portion of the tether 20 is inserted through the opening 24 to form a closed loop. The free end of the tether allows it to be inserted into an aperture of an object, and thereby be secured to the object including but not limited to zipper tabs on backpacks.

FIG. 4 shows the tether 20 in a secured configuration in which the mating portion 22 has been inserted through the opening 24, thereby forming a closed loop. Although shown as having a conical shape in the illustrated embodiment, the shape of the mating portion 22 is not critical as long as a portion of the mating portion 22 is slightly larger than a diameter of the opening 24. Due to the flexible nature of the tether 20, the mating portion 22 may be stretched during the securing operation, thereby decreasing (or otherwise deforming) the diameter of the mating portion 22 enough to pass through the opening 24. Once through the opening 24, the mating portion 22 returns to its original size and shape, thereby preventing the mating portion 22 from passing back through the opening 24 until it is again stretched (or otherwise deformed).

FIG. 5 shows an alternative embodiment of a tethered writing instrument 100 according to the teachings of the disclosure. In this embodiment, a second flexible tether 126 is provided on the fin 116. Of course, the tethers 120, 126 could be attached directly to the cap 114 if desired (i.e., the cap 114 need not include a fin 116). The opening 124 in this embodiment is disposed in the free end of the second tether 126. Similar to the embodiment of FIGS. 1-4, the mating portion 122 of the first tether 120 is placed through the opening 124 of the second tether 126 to provide a flexible closed loop which can be used to secure the tethered writing instrument 100 to an object. The first and second flexible tethers 120, 126 may be of different lengths, if desired.

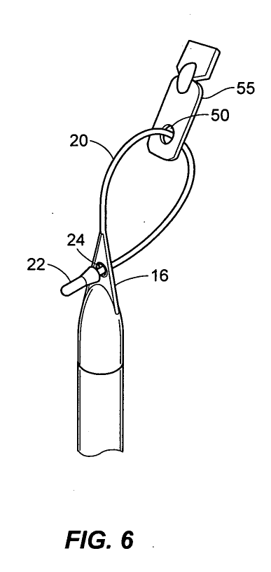

FIG. 6 shows the tether 20 secured through an aperture 50 in an object 55, for example, an aperture of a zipper tab on a backpack. To secure the writing instrument 10, the user inserts the mating portion 22 of the tether 20 through the aperture 50 in the object. Next, the user inserts the tether through the opening 24, which in the illustrated embodiment is disposed in the fin 16. After pulling the mating portion 22 of the tether 20 through to the other side of the opening 24, the tether 20 forms a closed loop interconnected with the object 55. The writing instrument 10 is then secured to the object until the user-removes the mating end 24 from the opening 24, as previously described. Thus, the writing instruments and other stationery objects according to the disclosure can be releasably and securably coupled to various objects including but not limited to backpacks, daily planners, binders, jackets, and other items including a ring or aperture

The flexible tether is preferably made from silicone rubbers and/or thermoplastic elastomers. The flexible tether typically has a Durometer range of approximately 25 to approximately 55, approximately 20 to approximately 50, and/or approximately 35 to approximately 45 Shore A. These durometer ranges produce a flexible tether that will be soft enough for the mating portion to be inserted through the opening, but hard enough to prevent accidental dislodgement of the flexible tether when the writing instrument is bumped or otherwise impacted. Higher Durometer readings would produce a mating end that is hard to insert through the opening.

An injection molding process is typically used to produce the flexible tether. The flexible tether could be made using an over-molding process or an insert-molding process to create a permanent adhesion to the cap or writing portion or to another stationery product described herein. Thus, the flexible tether could be integrated to the stationery product preventing loss or separation of the flexible tether from the stationery product. Additionally, over-molding the flexible tether onto the stationery product is an efficient means of manufacture, thus saving time and money in the manufacture of a writing instrument having a flexible tether. However, the flexible tether could be attached to the stationery product by virtually any acceptable means and need not be permanently attached, but could be temporarily or removably attached to facilitate replacement of a worn or broken tether. For example, the tether could be attached with an adhesive, or heat staking.

What is claimed is:

1. A writing instrument comprising:
a writing portion; and
a cap portion removably attached to the writing portion;
wherein one of the cap portion and the writing portion includes a tether extending therefrom and further includes an opening disposed therein.

2. The writing instrument of claim 1, wherein the tether and opening are disposed on the cap portion.

3. The writing instrument of claim 1, further including a fin extending from the cap portion.

4. The writing instrument of claim 3, wherein the opening is disposed on the fin.

5. The writing instrument of claim 4, wherein the tether extends from the fin.

6. The writing instrument of claim 1, wherein the mating portion is cone-shaped.

7. The writing instrument of claim 1, wherein the tether comprises a material selected from thermoplastic elastomers and silicone rubbers.

8. The writing instrument of claim 8, wherein the material has a durometer of about 25 to about 55 Shore A.

9. The writing instrument of claim 1, wherein the writing portion is selected from the group consisting of a pen, a pencil and a marker.

10. A writing instrument comprising:
a writing portion; and
a cap portion removably attached to the writing portion;
wherein the cap portion includes first and second tethers extending therefrom.

11. The writing instrument of claim 10, wherein a free end of the first tether includes an opening.

12. The writing instrument of claim 11, wherein the free end of the second tether terminates in a mating portion including a section having a diameter greater than the opening.

13. The writing instrument of claim 12, wherein the mating portion is cone shaped.

14. A method of securing a writing instrument to an object, comprising:
providing a tether and an opening on the writing instrument; and
inserting a free end of the tether through the opening thereby forming a closed loop.

15. The method of claim 14, further including inserting the free end of the tether through an aperture in an object prior to inserting the free end of the tether though the opening.

16. A stationery product comprising:
a body portion including a tether extending therefrom and further including an opening disposed therein.

17. The stationery product of claim 16, wherein the body portion is selected from the group consisting of a writing instrument, erasers, rulers, and pencil sharpeners.

18. The stationery product of claim 16, wherein the stationery product is a retractable writing instrument.
